(19) United States
(12) Patent Application Publication
(10) Pub. No.: US 2013/0205615 A1
(43) Pub. Date: Aug. 15, 2013

(54) METHOD AND APPARATUS FOR RECUPERATING HEAT FROM DRYER

(71) Applicant: GUY PRUD'HOMME, Mont-Royal (CA)

(72) Inventor: GUY PRUD'HOMME, Mont-Royal (CA)

(21) Appl. No.: 13/372,909

(22) Filed: Feb. 14, 2012

(51) Int. Cl. F26B 3/02; F26B 21/00

(52) U.S. Cl. 34/480; 34/82

(57) ABSTRACT

An apparatus for recuperating heat from a convection dryer comprises an exhaust air conduit having an exhaust inlet adapted to receive exhaust air from a convection dryer, and an exhaust outlet adapted to exhaust the exhaust air. An ambient air conduit has an ambient inlet adapted to receive ambient air, and an ambient outlet adapted to feed the ambient air toward a convection dryer. A heat exchanger unit has a first conduit portion within the exhaust air conduit and a second conduit portion within the ambient air conduit, the first conduit portion and the second conduit portion being arranged concurrently in a heat exchanger configuration for the ambient air to absorb heat from the exhaust air when passing therethrough. A filtering device is in the exhaust air conduit upstream of the heat exchanger unit for filtering airborne residue out of the exhaust air.

### CROSS-REFERENCE TO RELATED APPLICATION

The present application claims priority on a Canadian patent application filed on Feb. 13, 2014, the serial number of which has not yet been made available.

### FIELD OF THE APPLICATION

The present application relates to energy recuperation, for instance with laundry dryers, and to a method and apparatus for the recuperation of heat from hot air exhausted by laundry dryers.

### BACKGROUND OF THE ART

A common type of dryer for laundry operates by blowing heated air through a rotating tumbler in which clothes are tumbled. Upon exiting the dryer, the air is exhausted, often directly to the environment. Other types of specialized laundry dryers—without a tumbler—also exhaust air to the environment.

Exhaust air from dryers is often substantially warmer than the environmental air or the ambient air. Accordingly, energy is wasted to the environment when the dryer air is exhausted. The energy loss may be substantial in some applications, such as in commercial dryers of industrial laundry services. Moreover, in some countries, the air that is fed to the dryer is often quite cold and must be heated substantially to be used in a dryer. Hence, the energy consumption of laundry dryers may be substantial in given conditions, with a non-negligible part of the energy being exhausted to the environment.

### SUMMARY OF THE APPLICATION

It is therefore an aim of the present disclosure to provide a method and an apparatus for recuperating heat from dryers, such as commercial dryers.

Therefore, in accordance with the present application, there is provided an apparatus for recuperating heat from a convection dryer, comprising: an exhaust air conduit having an exhaust inlet adapted to receive exhaust air from a convection dryer, and an exhaust outlet adapted to exhaust the exhaust air; an ambient air conduit having an ambient inlet adapted to receive ambient air, and an ambient outlet adapted to feed the ambient air toward a convection dryer; and a heat exchanger unit having a first conduit portion within the exhaust air conduit and a second conduit portion within the ambient air conduit, the first conduit portion and the second conduit portion being arranged concurrently in a heat exchanger configuration for the ambient air to absorb heat from the exhaust air when passing therethrough; and a filtering device in the exhaust air conduit upstream of the heat exchanger unit for filtering airborne residue out of the exhaust air.

Further in accordance with the present disclosure, there is provided a method for recuperating heat from a convection dryer, comprising: receiving exhaust air from a convection dryer; receiving ambient air; filtering airborne residue out of the exhaust air; heating the ambient air by passing the exhaust air and the ambient air in a heat exchanger for the ambient air to absorb heat from the exhaust air; and feeding the heated ambient air toward the convection dryer.

### BRIEF DESCRIPTION OF THE DRAWINGS

FIG. 1 is a block diagram illustrating a method and apparatus for recuperating heat from a dryer;

FIG. 2 is a perspective view of the apparatus for recuperating heat from a dryer of FIG. 1, according to an embodiment;

FIG. 3 is a sectional view of the apparatus for recuperating heat of FIG. 2;

FIG. 4 is an exploded view of the apparatus for recuperating heat of FIG. 2; and

FIG. 5 is a perspective view of a filtering device of the apparatus for recuperating heat of FIG. 2.

### DESCRIPTION OF THE PREFERRED EMBODIMENTS

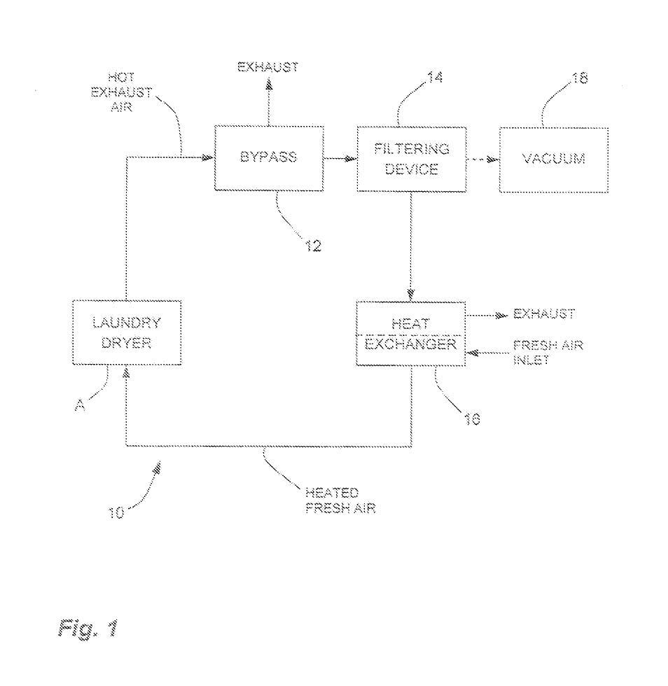

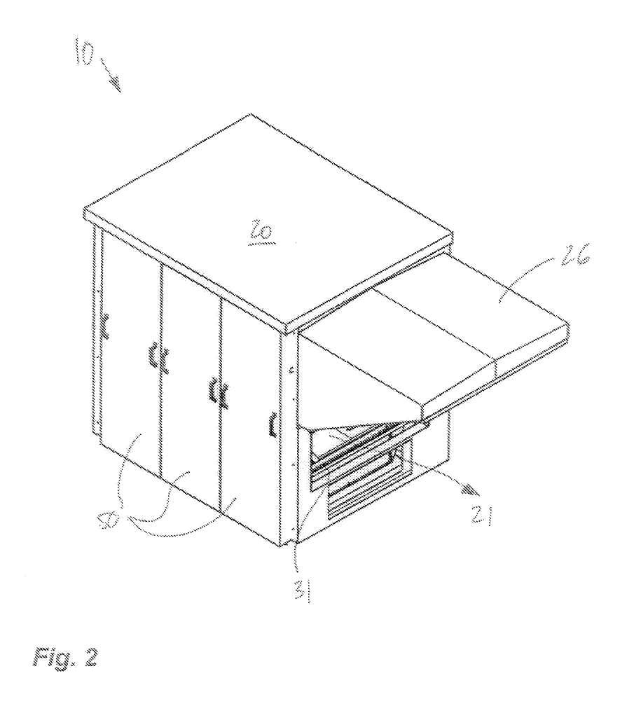

Referring to the drawings and more particularly to FIG. 1, there is illustrated an apparatus for recuperating heat from a dryer A at 10. An embodiment of the apparatus 10 is shown in FIGS. 2 to 5 and is described in further detail hereinafter. The dryer A is a dryer of the type used for drying laundry by convection heat transfer (hereinafter “convection”), for instance in industrial applications, such as industrial laundry services. The dryer A is fed with ambient air or fresh/cold outdoor air (i.e., ambient air) that is heated by the dryer A upstream of the tumbler or the drying chamber of the dryer. After convection in the drying chamber, the dryer may exhaust relatively hot air. Moreover, the exhausted air may have various airborne residues such as dust, lint, etc.

The temperature of the exhaust air varies in accordance with the moment of the drying cycle at which air is exhausted from the dryer. For instance, at the start of the cycle, clothes in the dryer have a greater level of humidity and are colder whereby the exhausted air is relatively colder. Towards the end of a drying cycle, the clothes are dryer and warmer whereby the exhaust air is at a higher temperature. Some dryers also operate cooldown sub-cycles at the end of a drying cycle and the exhausted air is relatively cold during this sub-cycle. As the dryer is used to remove moisture from clothes, the relatively humidity of the exhausted air may be high. Therefore, the apparatus 10 has a controller (i.e., a processing unit) that may control the operation of the apparatus 10 as a function of the drying parameters, as set forth below. The controller may include various types of temperature and pressure sensors measuring the drying parameters.

Referring to FIG. 1, the apparatus 10 has a bypass exhaust 12. In some instances, the exhaust air of the dryer A may not be in a suitable condition to warm up fresh air fed to the dryer A. For instance, when the drying cycle is initiated, during the cooldown period, and/or when the outside air is warm, it may not be possible to recuperate energy from the exhaust air. In other words, when the temperature differential between exhaust air and inlet air is below a predetermined threshold, the exhaust air may be exhausted to the environment, without energy recuperation. Accordingly, the bypass 12 may be used when the exhaust air cannot be used for warming up fresh air being fed to the dryer A.

A filtering device 14 is used to remove any residue from the exhaust air. Despite the fact that dryers are often equipped with lint filters, it may be desired to have an additional filtering device as the air will be subsequently circulated to the heat exchanger 16. Heat exchangers 16 comprise narrow passageways in which air circulates, to optimize the heat exchange with fresh air. Airborne particles may obstruct such narrow passageways, resulting in an efficiency loss in the heat exchanger and/or a pressure build-up upstream of the heat exchanger 16. Accordingly, the filtering device 14 provides an additional level of filtration to remove airborne residue that could otherwise affect the efficiency of the heat exchanger 16. The filtering device 14 may be a self-cleaning filtering device to reduce the amount of maintenance required on the apparatus 10.

The heat exchanger 16 is used to perform a heat exchange between the fresh inlet air and the exhaust air from the dryer A. According to an embodiment, the exhaust air and the fresh inlet air do not come into contact. The exhaust air from the dryer A releases heat to the inlet air, thereby warming up same. However, considering that the exhaust air and the inlet air are in a heat-exchange relation but do not come into contact, the inlet air does not absorb humidity or moisture from the exhaust air.

A vacuum 18 is connected to the filtering device 14 to operate vacuuming cycles to remove any residue on the upstream side of the filtering device 14. The vacuum 18 may be operated when a pressure differential above a given threshold is detected across the filtering device 14.

Now that the various stages of the apparatus 10 have been described, a method of operating same to warm up fresh inlet air is described. The apparatus 10 may operate as set forth in the present disclosure by way of the controller operating numerous temperature-, humidity- and/or pressure-measuring devices, installed in the apparatus 10 and in its surroundings (e.g., to measure outside air temperature, exhaust air temperature, etc.) with the measurements used to control the actuation of the apparatus 10. Moreover, the controller of the apparatus 10 may be connected to the processor of the dryer A for concurrent operation, and receive information of the portions of the drying cycle in operation. The controller of the apparatus 10 will actuate various components of the apparatus 10 to maximize the amount of energy recuperated from the dryer A.

According to an embodiment of the method, when a temperature difference above a given threshold is sensed between the air exhausted by the dryer A and the inlet air, a recuperation operation may be performed. The bypass 12 is closed so as to direct exhaust air to the filtering device 14.

In the filtering device 14, airborne residue may be removed from the exhaust air. The exhaust air is then fed to the heat exchanger 16 concurrently with fresh air typically coming from outdoors. In the heat exchanger 16, the exhaust air releases heat to the inlet air whereby same is warmed up. The warmed-up air may then be fed to the dryer A, which will further heat the inlet air to a suitable temperature to be used for clothes drying.

When a differential pressure across the filtering device 14 is above a given threshold, vacuum 18 may be operated to remove residue from the screen of the filtering device 14. During vacuuming, the bypass 12 may be opened to exhaust air. When the exhaust air does not meet recuperation conditions, the exhaust air may be exhausted by the opening of the bypass 12.

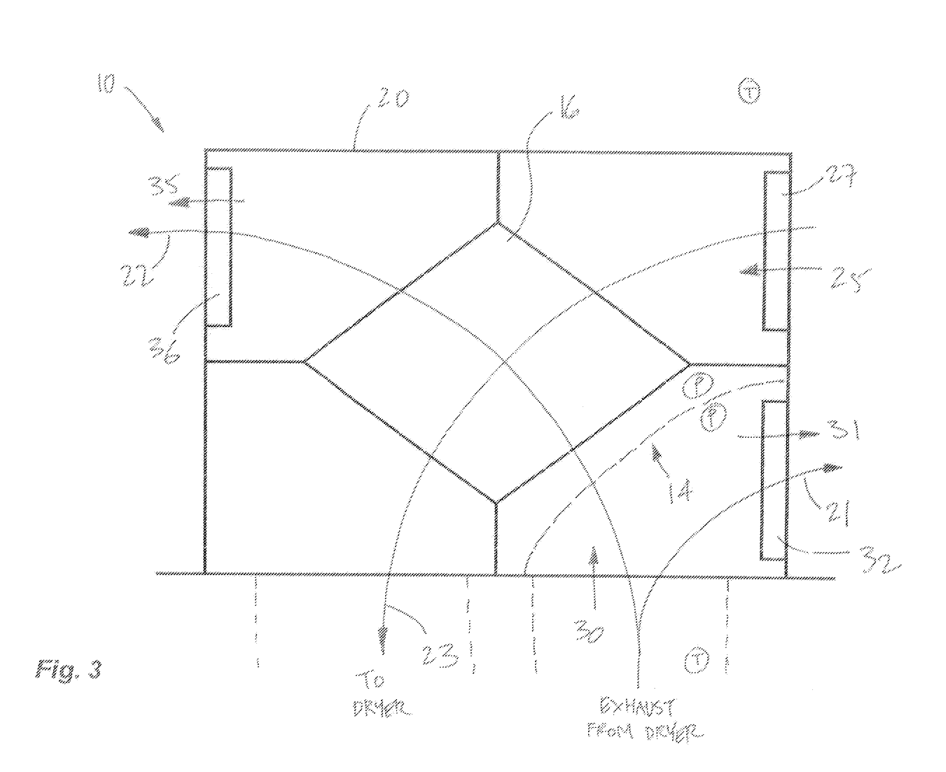

Now that the apparatus 10 has been generically described, as well as a method of operation thereof, an embodiment of the apparatus 10 is shown in greater detail. Referring concurrently to FIGS. 2 and 3, a casing of the apparatus 10 is generally shown at 20. The casing 20 is of the type that is rooftop mounted and therefore sits on an opening in the roof. According to an embodiment, the apparatus 10 is substantially self-contained in the casing 20, to facilitate its installation. In such a case, the feed and exhaust ducts of the industrial dryer are simply connected to the casing 20. Appropriate measures must be taken to sealingly fix the casing 20 to the rooftop during installation to prevent fluid infiltration through the rooftop.

As generally shown in FIG. 3, an interior of the casing 20 features numerous plates or walls to create ducts for the circulation of air therein through the heat exchanger 16. A bypass stream is schematically illustrated at 21. An exhaust air stream is generally shown at 22. An inlet air stream is generally shown at 23. In the illustrated embodiment, the exhaust air stream 22 and the inlet air stream 23 are in a crossing pattern, with the inlet air entering the casing 20 on a side opposite the outlet of the exhaust air.

Referring to FIGS. 2 and 3, fresh air inlet is generally shown at 25. A hood 26 may be provided in register with the fresh air inlet 25 for instance to prevent rain and/or snow from infiltrating the apparatus 10. A damper unit 27 is installed in the fresh air inlet 25. The apparatus 10 may comprise numerous such damper units, also known as louver units. These damper units typically comprise a frame supporting horizontal slats. The slats are pivotally mounted to the frame and their pivoting movement is motorized so as to be opened or closed. Alternatively, the movement of the slats may be caused by pressure differentials, where appropriate. The opening of the slats allows air to circulate therethrough while the closing of the slats generally prevents air circulation therethrough.

Referring concurrently to FIGS. 2 to 4, the casing 20 is shown having an exhaust air inlet 30. The exhaust air inlet 30 is connected to an outlet of dryer A (FIG. 1) by way of a ventilation duct, conduit, plenum, etc. Accordingly, exhaust air is fed to the apparatus 10 via the exhaust air inlet 30. A bypass outlet 31 is positioned adjacent to the exhaust air inlet 30. The bypass outlet 31 comprises a damper unit 32 in its opening. The damper unit 32 is similar in configuration to the damper unit 27. The slats of the damper unit 32 are therefore opened when the bypass is in operation to exhaust air that is not in condition to warm up the inlet air or when the dryer does not need a recuperation operation to be performed.

An exhaust air outlet 35 is provided on an opposite side of the casing 20. The exhaust air outlet 35 may also comprise a damper unit 36 similar to the damper units 27 and 32. Accordingly, exhaust air during a recuperation operation goes from the exhaust air inlet 30 to the exhaust air outlet 35 (along stream 22), and passes through the filtering device 14 and the heat exchanger 16 in the process.

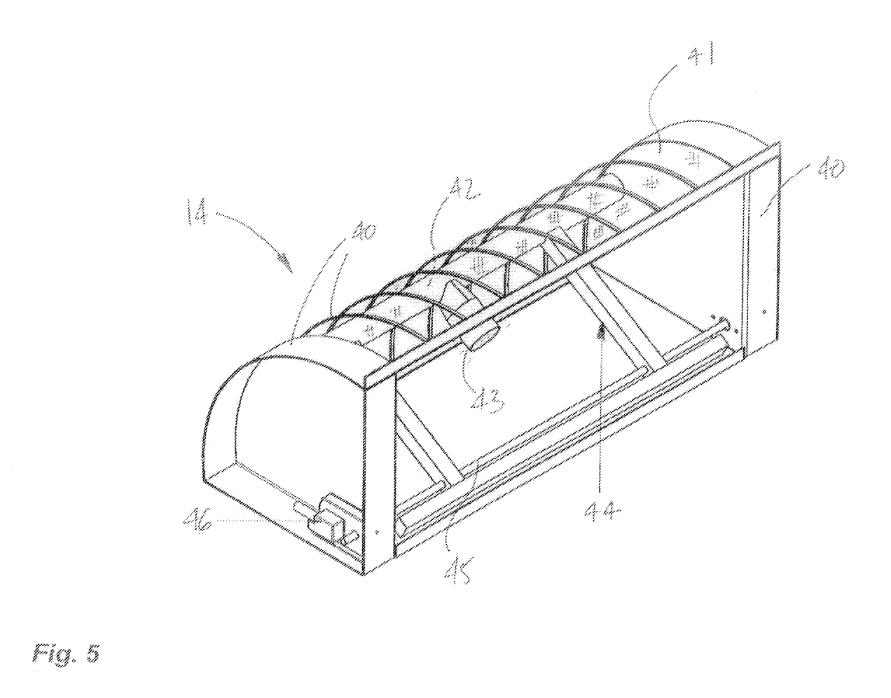

Referring concurrently to FIGS. 3 and 5, the filtering device 14 is shown in greater detail. The filtering device 14 has a semi-cylindrical shape by way of a structure 40. The structure 40 has a plurality of arched rods that support a screen 41. The screen 41 is made of any appropriate meshing device to remove airborne residue.

A vacuum manifold 42 extends the full length of the filtering device 14, and has a slit facing the screen 41. A pipe 43 is connected to a rear end of the vacuum manifold 42 so as to be connected to the vacuum 18 (FIG. 1). Therefore, when the vacuum 18 is operated, the slit in the vacuum manifold 42 will cause a vacuum condition along the screen 41, to remove residue lodged on the screen 41.

The vacuum manifold 42 is pivotally mounted to the structure 40 by arms 44 securing the vacuum manifold 42 to a pivot 45. An actuator unit 46 actuates the pivoting movement of the vacuum manifold 42 for the vacuum manifold 42 to move up and down along the screen 41 to remove residue therefrom.

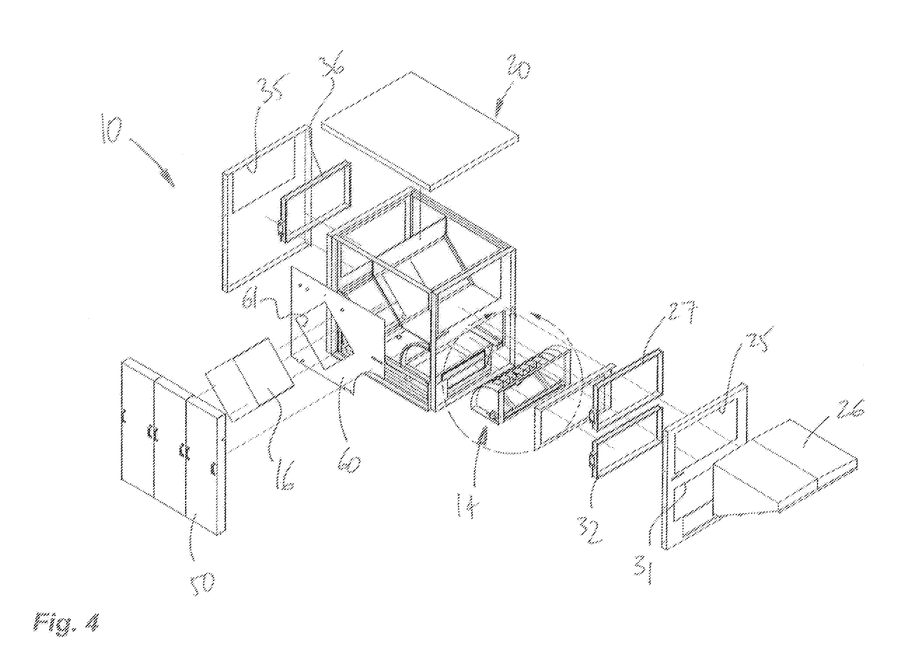

Referring to FIGS. 2-4, doors 50 may be provided on a side of the casing 20 to access the components. A side plate 60 shown in FIG. 4 has an opening 61 for the insertion therein of the heat exchanger 16. For instance, the heat exchanger 16 may come in a block that is mounted to a carriage to be moved in and out of the casing 20 for maintenance purposes. The heat exchanger 16 is typically a plate heat exchanger having two sets of channels, respectively aligned with the exhaust air stream 22 and the inlet air stream 23 for heat therebetween.

It is pointed out that there may be moisture build-ups on the heat exchanger 16, whereby the casing 20 may be provided with a draining system for both the exhaust air stream 22 and the inlet air stream 23. The draining system collects moisture by way of a gutter at the bottom of the heat exchanger and drains the moisture away from the apparatus 10.

According to an embodiment, the streams may be induced by the dryer A, with the apparatus 10 not adding blowing actuation to the streams. In relying solely on the convection dryer A to create the air streams, the energy consumption of the apparatus 10 is minimized. It may also be considered to add fans within the casing 20 to create the streams, for instance to optimize the heat exchange between streams.

The reclaim of heat from the exhaust air reduces energy consumption. Moreover, by feeding preheated air to the dryer A, the drying cycle time may be reduced, thereby causing an increase in load capacity of the dryer A.

1. A method for recuperating heat from a convection dryer, comprising:
receiving exhaust air from a convection dryer;
receiving ambient air;
filtering airborne residue out of the exhaust air;
heating the ambient air by passing the exhaust air and the ambient air in a heat exchanger for the ambient air to absorb heat from the exhaust air; and
feeding the heated ambient air toward the convection dryer.

2. The method according to claim 1, further comprising monitoring the temperature of the exhaust air and the ambient air, and exhausting the exhaust air rather than passing same in the heat exchanger if a temperature differential between the exhaust air and the ambient air is below a given threshold.

3. The method according to claim 1, further comprising monitoring a drying cycle of the convection dryer, and exhausting the exhaust air rather than passing same in the heat exchanger if the convection dryer is operating predetermined portion of the drying cycle.

4. The method according to claim 1, further comprising monitoring a pressure differential across of a filter filtering the airborne residue, and vacuuming residue off the filter when the pressure differential is above a given threshold.

5. The method according to claim 4, wherein vacuuming comprises automatically displacing a vacuum manifold across an upstream surface of the filter.

6. The method according to claim 1, wherein receiving ambient air comprises receiving ambient air from outdoors.

7. The method according to claim 1, wherein the steps are performed in a single casing.

8. The method according to claim 7, wherein the steps of receiving ambient air and exhaust air, and the step of heating the ambient air comprise relying solely on the convection dryer to produce the air streams induced by the convection dryer without using blowing means in the single casing.

9. An apparatus for recuperating heat from a convection dryer, comprising:
an exhaust air conduit having an exhaust inlet adapted to receive exhaust air from a convection dryer, and an exhaust outlet adapted to exhaust the exhaust air;
an ambient air conduit having an ambient inlet adapted to receive ambient air, and an ambient outlet adapted to feed the ambient air toward a convection dryer; and
a heat exchanger unit having a first conduit portion within the exhaust air conduit and a second conduit portion within the ambient air conduit, the first conduit portion and the second conduit portion being arranged concurrently in a heat exchanger configuration for the ambient air to absorb heat from the exhaust air when passing therethrough; and
a filtering device in the exhaust air conduit upstream of the heat exchanger unit for filtering airborne residue out of the exhaust air.

10. The apparatus according to claim 9, further comprising a bypass outlet in the exhaust air conduit adapted to outlet exhaust air upstream of the filtering device.

11. The apparatus according to claim 9, further comprising a single casing accommodating the conduits, the heat exchanger unit and the filtering device.

12. The apparatus according to claim 11, wherein exhaust outlet and the ambient inlet are on opposite lateral faces of the casing.

13. The apparatus according to claim 11,, wherein the exhaust air conduit and the ambient air Conduit are transverse to one another, with the heat exchanger unit being at an intersection between the conduits.

14. The apparatus according to claim 9, wherein the filtering device comprises a screen, a vacuum manifold displaceable to vacuum residue an upstream surface of the screen, and a vacuum connected to the vacuum manifold.

15. The apparatus according to claim 10, further comprising temperature sensors monitoring the temperature of the exhaust air and the ambient air, and a controller actuating a damper unit in the bypass outlet to exhaust air rather than passing same in the heat exchanger if a temperature differential between the exhaust air and the ambient air is below a given threshold.

16. The apparatus according to claim 10, further a controller monitoring a drying cycle of the convection dryer, and actuating a damper unit in the bypass outlet to exhaust air rather than passing same in the heat exchanger if the convection dryer is operating a predetermined portion of the drying cycle.

17. The apparatus according to claim 14, further comprising pressure sensors monitoring a pressure differential across the filtering device, and a controller for actuating the vacuum when the pressure differential is above a given threshold.

18. The apparatus according to claim 9, wherein the apparatus is without blowing means.
